(19) United States
(12) Patent Application Publication
(10) Pub. No.: US 2009/0257455 A1
(43) Pub. Date: Oct. 15, 2009

(54) Method and apparatus for synchronizing timing of signal packets

(75) Inventors: Rafid A. Sukkar, Aurora, IL (US); Peng Zhang, Buffalo Grove, IL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Operations, Inc., Naperville, IL (US)

(21) Appl. No.: 12/082,890

(22) Filed: Apr. 15, 2008

(51) Int. Cl. H04J 3/06

(52) U.S. Cl. 370/503

(57) ABSTRACT

In some communications systems, unsynchronized near-end and far-end packets of communications signals can reduce or impair performance of processing of packets, such as to the case of Coded Domain Media Quality Enhancement. Therefore, a system may synchronize the incoming signals to enhance quality. A relative delay determination module according to an example embodiment of this invention determines a synchronization and relative delay between packets belonging to different packet streams arriving at a network node in a packet-based network by computing a time synchronization parameter based on a time reference of timestamps of the signals and reports the relative delay to a module making use of the relative delay such as a voice quality enhancement or an echo control module. By synchronizing the packets at the location within the network, source clocks at end or edge nodes of the network can operate with reduced synchronization, simplifying network operations and management thereof.

### BACKGROUND OF THE INVENTION

In coded-domain signal processing applications, an input signal typically arrives in the form of packets over a packet network. In some coded-domain applications such as acoustic echo control, the network receives more than one input signal. For example, in the coded-domain echo control application, the network receives two input signals, namely the signal from the far-end speaker (reference signal) and the signal from the near-end speaker (echo signal). Both the near-end and the far-end signals arrive as packets into the coded-domain echo control system. Additionally, these two input packet streams typically experience different amounts of network delays introduced by the packet network.

### SUMMARY OF THE INVENTION

A method or corresponding apparatus in an exemplary embodiment of the present invention determines a time synchronization parameter as a function of time references generated at originating endpoints of a near-end signal and a far-end signal at an entity where time synchronization is to be determined. The time synchronization parameter is used to compute a set of time difference parameters between a near-end packet of a near-end signal and each far-end packet in a buffer. The buffer contains consecutively arranged packets of a far-end signal. The packets are arranged in the buffer corresponding to a preset delay range as a function of the time synchronization are then computed as a function of the time synchronization parameter, and at least one index is reported to a module making use of the preset delay range.

Additionally, an example embodiment of the present invention aligns signals in a packet-based network by determining a relative delay between the signals based on their source and local timestamps. The determined relative delay is then reported to a module making use of the relative delay.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of a telephone network that employs a Media Quality Enhancement (MQE) module employing a relative delay determination module according to an example embodiment of the present invention;

FIG. 2 is a network diagram of a telephone network that employs a Media Quality Enhancement (MQE) module employing a relative delay determination module using an example embodiment of this invention;

FIG. 3 is a flow chart illustrating the operation of the time synchronization and relative delay determination;

FIG. 4 is a flow chart of an example embodiment of the relative delay determination module;

FIG. 5 is a high level flow diagram of an example embodiment of the present invention; and

FIG. 6 is a flow diagram of an example embodiment of the present invention.

### DETAILED DESCRIPTION OF THE INVENTION

A description of example embodiments of the invention follows.

An example embodiment of the present invention relates to Media Quality Enhancement applications such as Voice Quality Enhancement (VQE) in telephony networks. In order to increase voice quality, telephone service providers are motivated to employ VQE features, such as acoustic echo control or acoustic echo cancellation.

Synchronizing input streams (i.e., the near-end and far-end signal packets) to remove their corresponding differing network delays improves performance of processing the input streams and may be used to enhance media (e.g., voice) quality in packet based network, such as in a coded domain network employing coded-domain echo control. The relative delay between a given near-end packet and previously arrived far-end packets can then be determined based on the information obtained from the packets after being synchronized.

An example embodiment of this invention describes a method for determining a relative delay between packets of different packet streams in a packet-based network.

According to one embodiment of this invention, as a part of a packet header, such as that of a real-time transport protocol packet, the packet is given a timestamp, representing the time when the endpoint (source) generated that packet. This timestamp is denoted as the source timestamp. Since the source timestamp is generated at the source, it contains no network delays. Additionally, when a packet arrives at a receiving system or node in the packet-based network (e.g., coded-domain (CD) processing system), the receiving system or node in the packet-based network timestamps the packet with a second timestamp, denoted as the local timestamp. The local timestamp represents the time at which the packet arrives at the system. In contrast to the source timestamp, the local timestamp may suffer from various network delays. The source timestamps of the packets of the two streams are independent while the local timestamps of the packets of the two streams are based on the same clock. Thus, under this embodiment of the invention, the different streams need to be time-synchronized based on their source and local timestamps in order to simplify the processing of the two streams in systems such as coded-domain echo control.

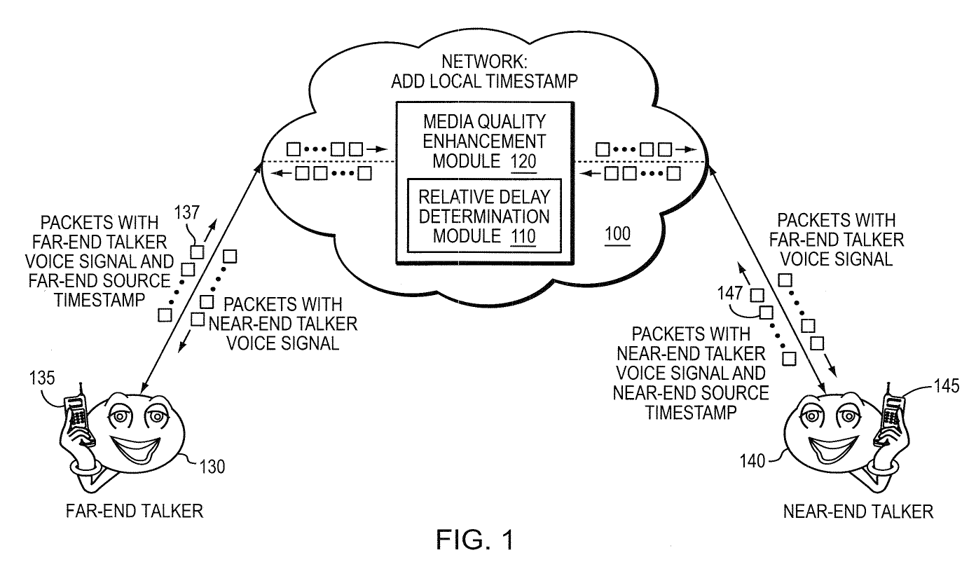

FIG. 1 illustrates an example telephony network 100 that employs a relative delay determination module 110 embedded in its media quality enhancement module 120. A far-end talker 130, using a far-end talker's phone 135, sends out packets 137, timestamped at the source (e.g., phone 135 used by the far-end talker 130 or corresponding base transceiver station (not shown)) and containing a representation of a far-end talker's acoustic signal, to the network 100. Similarly, a near-end talker 140 transmits packets 147 timestamped at the source (e.g., phone 145 used by the near-end talker 140 or corresponding base transceiver station (not shown)) and containing a representation of the near-end talker acoustic signal to the network 100. The media quality enhancement module 120 of the network 100, in turn, receives the far-end and near-end talker's packets 137, 147 and assigns a local timestamp to each packet.

Once the packets 137, 147 are assigned their respective timestamps, the relative delay determination module 110 embedded in the media quality enhancement module 120 determines the relative delay between the packets 137, 147 as a function of their source and local timestamps. The determined relative delay is then reported to a module that makes use of this information, such as a media quality enhancement (MQE) module 120.

In accordance with the foregoing, a method or corresponding apparatus in an example embodiment of the present invention determines a time synchronization parameter as a function of time references generated at originating endpoints of a near-end signal and a far-end signal and at an entity, where time synchronization is to be determined. The time synchronization parameter is used to compute a set of time difference parameters between a near-end packet of a near-end signal and each far-end packet in a buffer. The buffer contains consecutively arranged packets of a far-end signal. The packets are arranged in the buffer corresponding to a preset delay range as a function of the time synchronization parameter. The indices of packets in the buffer corresponding to a preset delay range are then computed as a function of the time synchronization parameter, and at least one index is reported to a module making use of the preset delay range.

Another example embodiment of the present invention aligns signals in a packet-based network by determining a relative delay between the signals based on their source and local timestamps. The determined relative delay is then reported to a module making use of the relative delay.

Yet another example embodiment of the present invention includes a computer program product including a computer readable medium having computer readable code stored thereon, which, when executed by a processor, causes the processor to compute a time synchronization parameter as a function of time references generated at originating endpoints of a near-end signal and a far-end signal and at an entity where time synchronization is to be determined. The time synchronization parameter is used to compute a set of time difference parameters between a near-end packet of a near-end signal and each far-end packet in a buffer. The buffer contains consecutively arranged packets of a far-end signal. The packets are arranged in the buffer corresponding to a preset delay range as a function of the time synchronization parameter. The indices of packets in the buffer corresponding to a preset delay range are then computed as a function of the time synchronization parameter, and at least one index is reported to a module making use of the preset delay range.

In the view of the foregoing, the following description illustrates example embodiments and features that may be incorporated into a system for controlling echo in the coded domain, where the term “system” may be interpreted as a system, a subsystem, apparatus, method, device or any combination thereof.

In order to determine the time synchronization parameter, the system may determine a time difference between local and source clocks of the endpoints originating and receiving the near-end and the far-end signals.

The system may compute the time synchronization parameter as a function of a time difference between local and source timestamps of a first arriving far-end packet and source and local timestamps of a first arriving near-end packet.

The system may determine the preset delay range based on expectancy of echo within a delay range.

The system may store packets in the buffer by storing a set of far-end packets corresponding to the preset delay range based on a newly arrived near-end packet. The system may determine a length for the buffer as a function of relative network delay statistics between the near-end and far-end packets. In order to store the packets in the buffer, the system may store a set of previously arrived far-end packets in the buffer. In order to store packets in the buffer, the system may store consecutively arranged packets and fill-in the gap in the consecutively arranged packets due to missing packets according to preset coding standards. The system may assign appropriate source timestamps to the filled-in packets. The system may assign these source timestamps based on timestamps of neighboring packets of the missing packets.

The system may determine a length for the buffer based on expected network delay statistics of the near-end and far-end packets.

The system may compute indices of packets by computing a minimum index and a maximum index.

The system may compute indices of packets by computing a range of indices corresponding to the preset delay range.

The system may synchronize the far-end and the near-end signals as a function of indices to control acoustic echo.

The system may compute indices of packets by computing a set of time differences corresponding to a set of far-end packets in the preset delay range. In order to compute the set of time differences corresponding to a set of far-end packets in the preset delay range. The system may compute a difference between time at the source clock originating each near-end packet, time at the source clock originating each far-end packet, and the time synchronization parameter.

The system may compute a location in the buffer that corresponds to a minimum value of the preset delay range. In order to compute the location in the buffer, the system may compute a minimum of absolute values of time differences determining a set of far-end packets in the preset delay range and the minimum value of the preset delay range. The system may compute the location in the buffer corresponding to the minimum value of the preset delay range to determine a lower bound for a range of packets in the buffer corresponding to the preset delay range.

The system may compute a location in the buffer corresponding to a maximum value of the preset delay range. In order to compute the location in the buffer, the system may compute a minimum of absolute values of time differences determining a set of far-end packets in the preset delay range and the maximum value of the preset delay range. The system may compute the location in the buffer corresponding to the maximum value of the preset delay range to determine an upper bound for a range of packets in the buffer corresponding to the preset delay range.

The system may report at least one index to a Voice Quality Enhancement module.

The system may report at least one index to an echo control module.

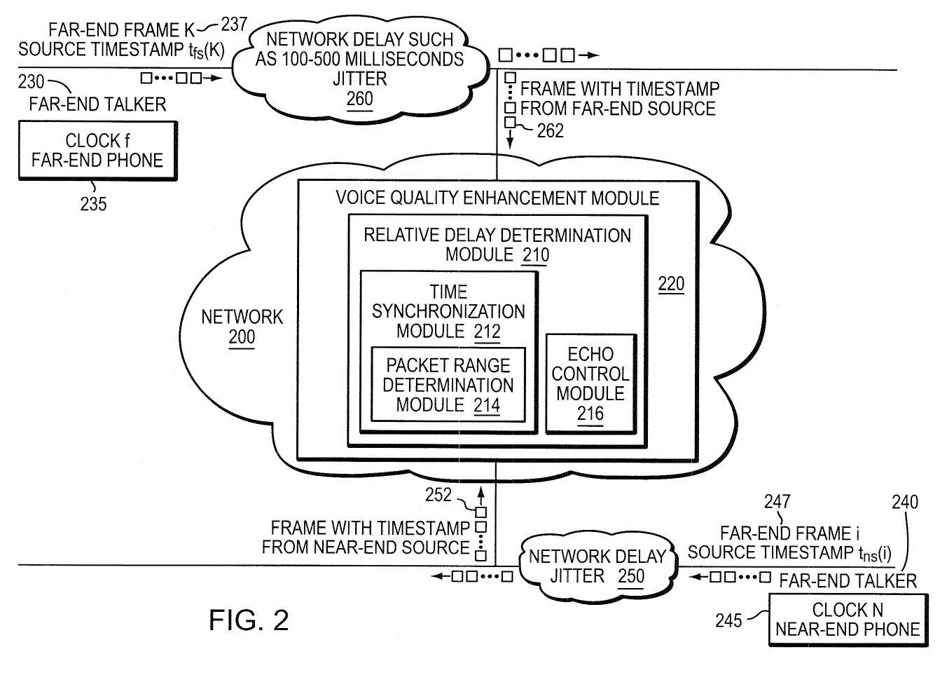

FIG. 2 illustrates a diagram of a telephone network 200 that employs a relative delay determination module 210 using an example embodiment of this invention. The relative delay determination module 210 is placed in the network 200, which connects the far-end talker 230 and the near-end talker 240. The relative delay determination module 210 is itself a module of a voice quality enhancement module 220, placed in the network 200 to increase the quality of voice in the communication between the far-end talker 230 and the near-end talker 240.

In this example embodiment, the near-end talker 240 transmits, using his/her phone 245 (near-end source), an acoustic signal, which is transmitted in the form of packets 247 to the network 200. The near-end source 245 assigns a source timestamp tₙₛ(.) to each packet transmitted to the network 200. For example, the near-end source 245 assigns a source timestamp tₙₛ(i) to the i-th frame (packet) transmitted to the network. Since the source timestamp is generated in the source before any possible network delays are introduced, there is no delay or jitter associated with the source timestamp.

Similarly, the far-end talker 230 uses his/her communication device 235 (far-end source) to transmit an acoustic signal in the form of packets 237 to the network 200. The far-end source 235 in turn assigns a source timestamp t_{fs}(.) to each packet transmitted to the network 200. For example, the far-end source 235 assigns a source timestamp t_{fs}(k) to the k-th frame transmitted to the network. Similar to the near-end case, since the far-end source 235 timestamp is generated in the source before any possible network delays are introduced, there is no delay or jitter associated with the source timestamp.

Network delay and jitter 250 may be introduced to the near-end packets transmitted from the near-end source 245. Similarly, the packets transmitted from the far-end source may experience jitter and network delay 260. The network delay for the far-end packets may be between 100-500 milliseconds.

The far-end 237 and near-end 247 packets subsequently arrive at a node or system in the packet-based network and are assigned their respective local timestamps, such as t_{fl}(k) for the k-th far-end frame and tₙₗ(i) for the i-th near-end frame. In this example embodiment, the network 200 includes a voice quality enhancement module 220, which in turn includes a relative delay determination module 210. The time synchronization module 212 of the relative delay determination module 210 computes a set of time difference parameters between a near-end packet 245 of the near-end talker's 240 acoustic signal and each far-end packet 235 arriving in a buffer. The buffer may contain consecutively arranged packets of the far-end signal.

The packet range determination module 214 employs the computed set of time difference parameters to compute indices of packets in the buffer corresponding to a preset delay range. In an example embodiment, the preset delay range may be between 100-500 milliseconds.

At least one index computed by the packet range determination module 214 is reported to a module that makes use of the preset delay range. In this example embodiment, the packet range determination module 214 reports the at least one index to an echo control module 216.

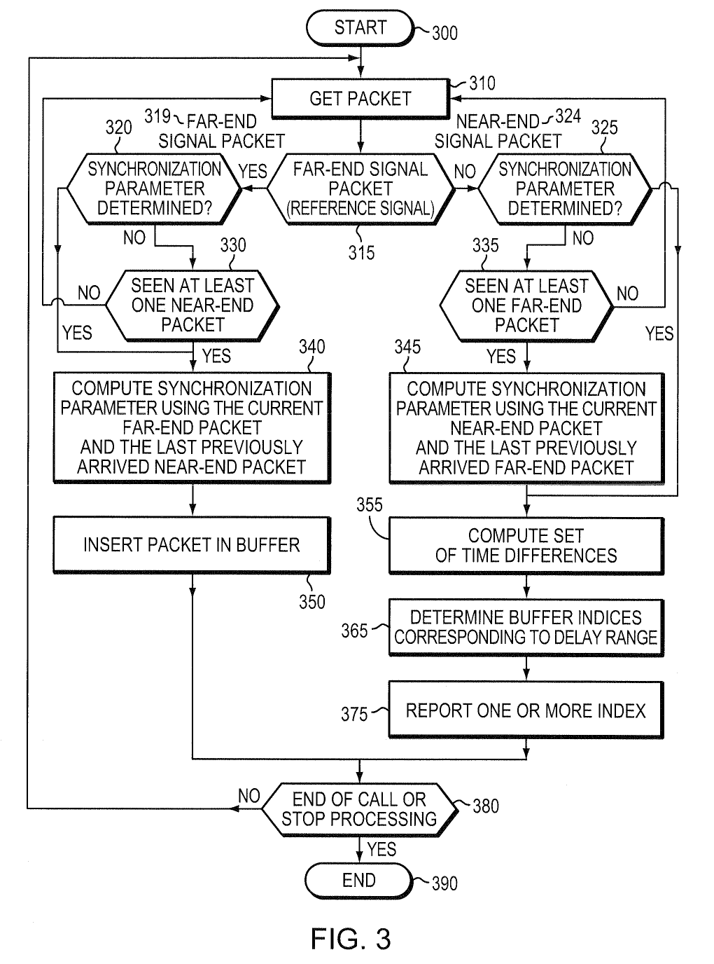

FIG. 3 illustrates a flow chart of the operation of the time synchronization and relative delay determination using an example embodiment of this invention.

In this example embodiment, the k-th frame of the far-end signal has the far-end source timestamp t_{fs}(k), and the far-end local timestamp t_{fl}(k). The value of i starts at 0 with the first far end packet and increments by one for each new far end packet.

Similarly, the i-th frame of the near-end signal has the near-end source timestamp tₙₛ(i) and the near-end local timestamp tₙₗ(i). The value of i in the near-end buffer starts at 0 with the first near end packet and increments by one for each new near end packet.

The example embodiment waits until at least one packet from each side of the call (far-end and near-end) arrives at the network node or system. If far-end packets 319 arrive before the first near-end packet 324 arrives, the system waits until the first near-end packet 324 arrives. Once the near-end packet 319 arrives, the frame in this near-end packet 324 is given a time index of i=0 (i.e., the 0-th near-end frame), and the frame in the previously arrived far-end packet 319 is given a time index of k=0 (i.e., the 0-th far-end frame). If near-end packets 324 arrive before the arrival of the first far-end packet 319, the system waits until the first far-end packet 319 arrives. In this case, after receiving the first far-end packet 319, the system waits until it receives the next near-end packet 324. Once the next near-end packet 324 arrives, the frame in this near-end packet 324 is given the time index i=0 (i.e., the 0-th near-end frame) and the frame in the previously arrived first far-end packet 319 is given time index k=0 (i.e., the 0-th far-end frame).

Once at least one packet from each the far-end and near end signal packet arrives, the system establishes a reference time 325 based on the 0-th far-end frame and the 0-th near-end frame. The time reference 325 is determined by computing the time synchronization parameter 320, 325 according to the following equation:

δ=(tₙₛ(0)−t_{fs}(0))−(tₙₗ(0)−t_{fl}(0))

In this example embodiment, in order to perform coded-domain echo control, the relative delay determination module 300 needs to determine the set of far-end packets that correspond to a certain delay range 365, relative to the newly arrived near-end packet. The delay range values varies from its minimum value Dₘᵢₙ to its maximum value Dₘₐₓ.

In one example embodiment, the delay range may be set to vary from 100-500 milliseconds. Given this delay range, the relative delay determination module 300 determines the set of far-end packets that correspond to this delay range of 100-500 milliseconds, relative to the near end packet. The specific delay range of Dₘᵢₙ to Dₘₐₓ may be obtained based on the expectancy of the occurrence of echo within a delay range.

In order to determine a desired set of far-end packets, the relative delay determination module 300 keeps a buffer of length N that stores the N previously arrived far-end packets. The ordering of the packets is preformed prior to storing in the buffer to ensure that consecutively ordered frames of the signal are stored in the buffer.

In one example embodiment, for an ideal case, where the near-end and the far-end packets do not experience any network delay, the buffer corresponds to 500 milliseconds worth of packets.

In another example embodiment, for a realistic case, the length of the buffer may increase depending on the expected network delay statistics of both the far-end and the near-end packets. The length of the buffer may depend on the relative network delay statistics between the near-end and far-end packets. Thus, the buffer should be large enough to hold the desired set of far-end packets given the relative network delay statistics.

If one or more packets are missing from the buffer due to packet loss or Discontinuous Transmission (DTX), the relative delay determination module 300 replaces the missing packets according to the specific coding standards used. Examples of such coding standards include Enhanced Variable Rate Codec (EVRC) or Adaptive Multi-Rate (AMR) standards.

The relative delay determination module 300 also assigns an appropriate source timestamp t_{fs}(k) to the packet filling-in the spot of a missing packet in the buffer. This timestamp assignment is readily done since the source timestamp increments by an exact and deterministic amount from one packet to the next.

Upon arrival of a near-end packet i, the relative delay determination module 300 computes a set of relative delay parameters (time difference parameters) d(0) through d(N−1) for 0≦n≦N−1 340 to determine the set of far-end packets in the desired delay range. Specifically the relative delay values corresponding to d(0) through d(N−1) for 0≦n≦N−1 340 are calculated according to the equation:

d(k−b(0))=tₙₛ(i)−δ−t_{fs}(k), b(0)≦k≦b(0)+N−1

In the above equation, b(0) corresponds to the packet index of the oldest packet in the far-end buffer.

Once the relative delay values of d(0) through d(N−1) for 0≦n≦N−1 are calculated, the relative delay determination module 300 determines the buffer location that corresponds to Dₘᵢₙ using the following equation:

$${j}_{min} = {arg min}_{n} [ abs ( d ( n ) - {D}_{min} ) ] \qquad 0 \leq n \leq N - 1$$

Similarly, the relative delay determination module 300 determines the buffer location that corresponds to Dₘₐₓ using the following equation:

$${j}_{max} = {arg min}_{n} [ abs ( d ( n ) - {D}_{max} ) ] \qquad 0 \leq n \leq N - 1$$

Thus, the set of far-end packets in the far-end buffer 310 that their indices are in the range jₘᵢₙ≦j≦jₘₐₓ represent the set of far-end packets corresponding to the delay range of Dₘᵢₙ to Dₘₐₓ relative to the newly arrived near-end packet.

The relative delay determination module 300 may report 375 at least one of the calculated indices of packets in the buffer to a module making use of the preset delay range. The module making use of the preset delay range may be an echo control module. This module may employ the reported index to synchronize far-end and near-end signals. The synchronization of far-end and near-end signals may be used to control echo.

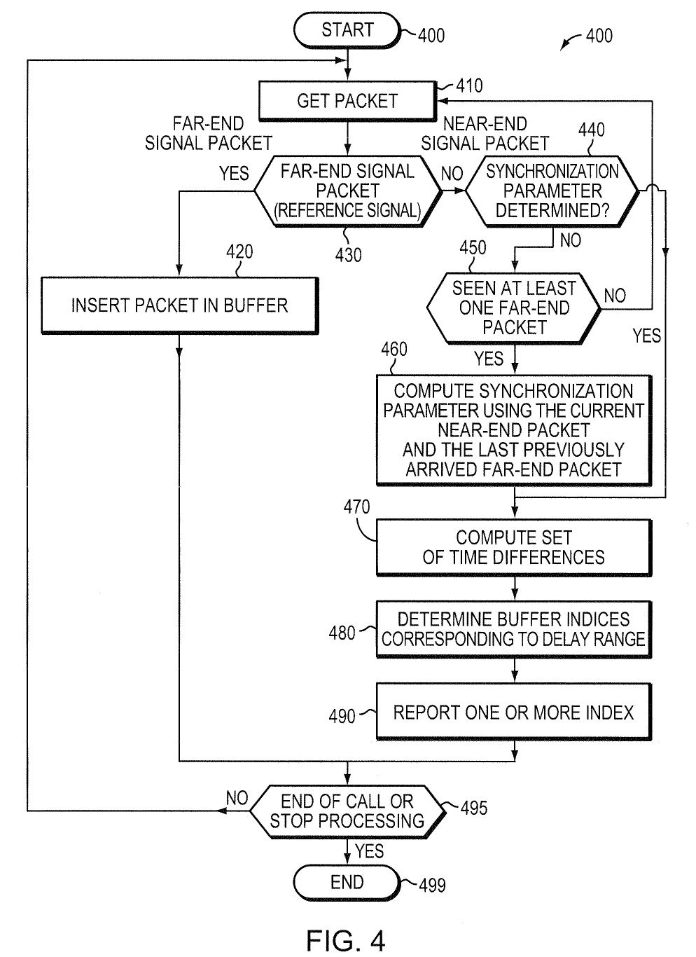

FIG. 4 is a flow chart of an example embodiment of the relative delay determination module.

In this example embodiment of the delay determination, the relative delay determination module 400 waits until at least one packet from far-end side of the call arrives at the network node or system 450. Upon its arrival, the frame in the last previously arrived far-end packet 450 is given a time index of k=0 (i.e., the 0-th far end frame).

The example embodiment then calculates the time synchronization parameter 460 based on the last previously arrived far-end packet, which was given a time index k=0, and the current near-end packet which was given a time index i=0. The time synchronization parameter 460 is determined according to the following equation:

δ=(tₙₛ(0)−t_{fs}(0))−(tₙₗ(0)−t_{fl}(0)).

The example embodiment then computes a set of time differences 470 as a function of the source timestamps of the far-end and the near-end packets as well as the time synchronization parameter. Specifically, the set of time differences, d(0) through d(N−1) for 0≦n≦N−1 are calculated according to the equation:

d(k−b(0))=tₙₛ(i)−δ−t_{fs}(k), b(0)≦k≦b(0)+N−1

In this example embodiment, in order to perform coded-domain echo control, the relative delay determination module 400 needs to determine the set of far-end packets that correspond to a certain delay range 480, relative to the newly arrived near-end packet. The delay range values varies from its minimum value Dₘᵢₙ to its maximum value Dₘₐₓ.

The relative delay determination module 400 may employ the preset delay range to compute indices of packets in the buffer 480. Specifically, the relative delay determination module 400 may calculate a minimum index and a maximum index corresponding to the preset delay range.

The relative delay determination module 400 may report at least one of the indices of packets in the buffer 490 to a module making use of the preset delay range. The module making use of the preset delay range may be an echo control module. This module may employ the reported index to synchronize far-end and near-end signals. The synchronization of far-end 4 and near-end signals may be used to control echo.

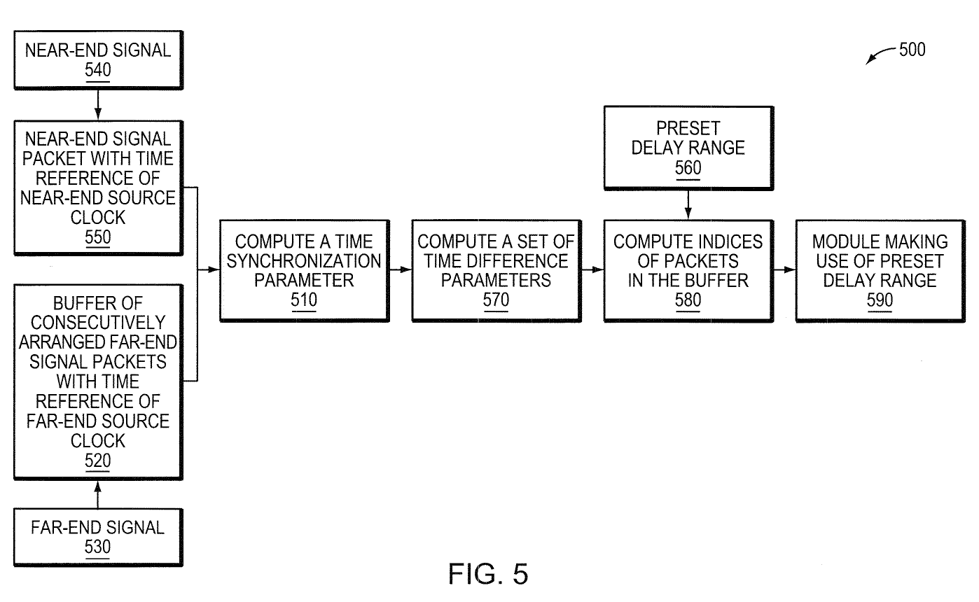

FIG. 5 is a high level flow diagram 500 of an example embodiment of the present invention. This example embodiment employs the near-end signal 540 consisting of near-end signal packets with time reference of near-end source clock 550. The far-end signal 530 is in the form of a buffer of consecutively arranged far-end signal packets with time reference of far-end source 520. The example embodiment calculates a time synchronization parameter 510 as a function of a time reference of source and local clocks of endpoints originating and receiving the near-end signal and the far-end signal 550, 520. The example embodiment, subsequently, calculates a set of time difference parameters 570 by computing a set of time difference parameters between a near-end packet of a near-end signal 550 and each far-end packet in a buffer 520 having stored therein consecutively arranged packets of a far-end signal 530 as a function of the time synchronization parameter 510. The example embodiment, subsequently, computes indices of packets in the buffer 580 as a function of a preset delay range 560. Finally, the example embodiment reports at least one computed index to a module making use of the preset delay range 590.

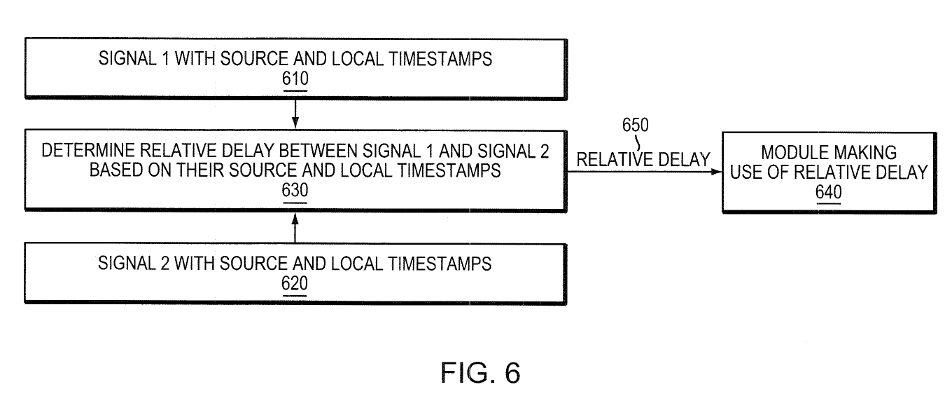

FIG. 6 is a flow diagram of an example embodiment of the present invention. The example embodiment receives a first signal with source and local timestamps 610 as well as a second signal with source and local timestamps 620. The example embodiment then determines the relative delay 630 between the first signal 610 and the second signal 620 based on their source and local timestamps. Finally, the example embodiment reports the determined relative delay 650 to a module making use of the relative delay 640.

Another application is time synchronizing the audio and video portion of a video signal including two or more streams, one for the audio and one for the video. Another application is time synchronizing two or more different video streams.

Another example embodiment of the present invention may include a computer program product employing a computer readable medium having computer readable code stored thereon. The computer readable code, when executed by a processor, may cause the processor to compute a set of time difference parameters between a near-end packet of a near-end signal and each far-end packet in a buffer having stored therein consecutively arranged packets of a far-end signal as a function of a time reference of source clocks of endpoints originating the near-end signal and the far-end signal. The computer readable code, when executed by a processor, may also cause the processor to compute indices of packets in the buffer corresponding to a preset delay range as a function of the set of time difference parameters. The computer readable code, when executed by a processor, may also cause the processor to report at least one index to a module making use of the preset delay range.

While this invention has been particularly shown and described with references to example embodiments thereof, it will be understood by those skilled in the art that various changes in form and details may be made therein without departing from the scope of the invention encompassed by the appended claims.

It should be understood that although some of the example embodiments illustrate computing a time synchronization parameter, time difference parameter, and indices of packets in a buffer for two streams, other example embodiments may calculate the parameters and indices for three or more streams, such as for multi-party conference calls, multi-party network action computer game applications, and so forth. Multiple buffers and other structures or procedures may be employed similar to the two stream embodiments operate.

What is claimed is:

1. A method for synchronizing timing of signal packets of different packet streams in a packet-based network, the method comprising:
computing a time synchronization parameter as a function of time references generated at originating endpoints of a near-end signal and a far-end signal and at an entity where time synchronization is to be determined;
computing a set of time difference parameters between a near-end packet of a near-end signal and each far-end packet in a buffer having stored therein consecutively arranged packets of a far-end signal as a function of the time synchronization parameter;
computing indices of packets in the buffer corresponding to a preset delay range as a function of the time synchronization parameter; and
reporting at least one index to a module making use of the preset delay range.

2. The method of claim 1 wherein computing the time synchronization parameter includes computing a time difference between local and source clocks of the endpoints originating and receiving the near-end and the far-end signals.

3. The method of claim 1 wherein computing the time synchronization parameter includes computing a time difference between local and source timestamps of a first arriving far-end packet and source and local timestamps of a first arriving near-end packet.

4. The method of claim 1 further including determining the preset delay range based on expectancy of echo within a delay range.

5. The method of claim 1 wherein storing packets in the buffer includes storing a set of far-end packets corresponding to the preset delay range based on a newly arrived near-end packet.

6. The method of claim 5 further including determining a length for the buffer as a function of relative network delay statistics between the near-end and far-end packets.

7. The method of claim 5 further comprising storing a set of previously arrived far-end packets in the buffer.

8. The method of claim 5 wherein storing the packets includes storing consecutively arranged packet and filling-in gaps in the consecutively arranged packets due to missing packets according to preset coding standards.

9. The method of claim 8 further comprising assigning to missing packets appropriate source timestamps based on timestamps of neighboring packets of the missing packets.

10. The method of claim 1 further comprising determining a length for the buffer as a function of expected network delay statistics of the near-end and far-end packets.

11. The method of claim 1 wherein computing the indices of packets includes computing a minimum index and a maximum index.

12. The method of claim 1 wherein computing the indices of packets includes computing a range of indices corresponding to the preset delay range.

13. The method of claim 1 further comprising synchronizing the far-end and the near-end signals as a function of the indices to control acoustic echo.

14. The method of claim 1 wherein computing the indices of packets includes computing a set of time differences corresponding to a set of far-end packets in the preset delay range.

15. The method of claim 14 wherein computing the set of time differences 5 corresponding to the set of far-end packets in the preset delay range includes computing a difference between time at the source clock originating each near-end packet, time at the source clock originating each far-end packet, and the time synchronization parameter.

16. The method of claim 1 further including computing a location in the buffer corresponding to a minimum value of the preset delay range.

17. The method of claim 16 wherein computing the location in the buffer includes computing a minimum of absolute values of time differences determining a set of far-end packets in the preset delay range and the minimum value of the preset delay range.

18. The method of claim 16 further comprising computing the location in the buffer corresponding to the minimum value of the preset delay range to determine a lower bound for a range of packets in the buffer corresponding to the preset delay range.

19. The method of claim 1 further including computing a location in the buffer corresponding to a maximum value of the preset delay range.

20. The method of claim 19 wherein computing the location in the buffer includes computing a minimum of absolute values of time differences determining a set of far-end packets in the preset delay range and the maximum value of the preset delay range.

21. The method of claim 19 further comprising computing the location in the buffer corresponding to the maximum value of the preset delay range to determine an upper bound for a range of packets in the buffer corresponding to the preset delay range.

22. The method of claim 1 further comprising reporting at least one index to a Voice Quality Enhancement module.

23. The method of claim 1 further comprising reporting at least one index to an echo control module.

24. An apparatus for determining a time synchronization and relative delay between packets belonging to different packet streams in a packet-based network comprising:
a time synchronization computation unit to compute a time synchronization parameter as a function of time references generated at originating endpoints of a near-end signal and a far-end signal and at an entity where time synchronization is to be determined;
a parameter computation unit to compute a set of time difference parameters between a near-end packet of a near-end signal and each far-end packet in a buffer having stored therein consecutively arranged packets of a far-end signal as a function of the time synchronization parameter;
an index computation unit to compute indices of packets in the buffer corresponding to a preset delay range as a function of the time synchronization parameter; and
a reporting unit to report at least one index to a module making use of the preset delay range.

25. The apparatus of claim 24 wherein the time synchronization computation unit is arranged to compute the time synchronization parameter as a function of a time difference between local and source clocks of the endpoints originating and receiving the near-end and the far-end signals.

26. The apparatus of claim 24 wherein the time synchronization computation unit is arranged to compute the time synchronization parameter as a function of a time difference between local and source timestamps of a first arriving far-end packet and source and local timestamps of a first arriving near-end packet.

27. The apparatus of claim 24 further including a preset delay computation unit to determine the preset delay range based on expectancy of echo within a delay range.

28. The apparatus of claim 24 wherein the buffer is configured to store packets based on storing a set of far-end packets corresponding to the preset delay range based on a newly arrived near-end packet.

29. The apparatus of claim 28 further including a buffer length computation unit arranged to determine a length for the buffer as a function of relative network delay statistics between the near-end and far-end packets.

30. The apparatus of claim 28 further comprising storing a set of previously arrived far-end packets in the buffer.

31. The apparatus of claim 28 wherein the buffer is configured to store consecutively arranged packets by filling-in gaps in the consecutively arranged packets due to missing packets according to preset coding standards.

32. The apparatus of claim 31 further comprising an assignment unit to assign to missing packets appropriate source timestamps based on timestamps of neighboring packets of the missing packets.

33. The apparatus of claim 28 further comprising a buffer length computation unit arranged to determine a length for the buffer as a function of expected network delay statistics of the near-end and far-end packets.

34. The apparatus of claim 24 wherein the index computation unit computes the indices of packets as a function of computing a minimum index and a maximum index.

35. The apparatus of claim 24 wherein the index computation unit computes the indices of packets as a function of computing a range of indices corresponding to the preset delay range.

36. The apparatus of claim 24 further comprising a synchronization unit to synchronize the far-end and the near-end signals as a function of the indices to control acoustic echo.

37. The apparatus of claim 24 wherein the index computation unit is arranged to compute the indices of packets by computing a set of time differences corresponding to a set of far-end packets in the preset delay range.

38. The apparatus of claim 37 wherein the index computation unit is arranged to compute the set of time differences corresponding to the set of far-end packets in the preset delay range by computing a difference between time at the source clock originating each near-end packet, time at the source clock originating each far-end packet, and the time synchronization parameter.

39. The apparatus of claim 24 further including a computation unit to compute a location in the buffer corresponding to a minimum value of the preset delay range.

40. The apparatus of claim 39 wherein the computation unit computes the location in the buffer based on computing a minimum of absolute values of time differences determining a set of far-end packets in the preset delay range and the minimum value of the preset delay range.

41. The apparatus of claim 40 further comprising a computation unit to compute the location in the buffer corresponding to the minimum value of the preset delay range to determine a lower bound for a range of packets in the buffer corresponding to the preset delay range.

42. The apparatus of claim 24 further including a computation unit to compute a location in the buffer corresponding to a maximum value of the preset delay range.

43. The apparatus of claim 42 wherein the computation unit is arranged to compute location in the buffer based on computing a minimum of absolute values of time differences determining a set of far-end packets in the preset delay range and the maximum value of the preset delay range.

44. The apparatus of claim 42 further comprising a computation unit to compute the location in the buffer corresponding to the maximum value of the preset delay range to determine an upper bound for a range of packets in the buffer corresponding to the preset delay range.

45. The apparatus of claim 24 wherein the reporting module reports at least one index to a Voice Quality Enhancement module.

46. The apparatus of claim 24 wherein the reporting module reports at least one index to an echo control module.

47. A computer program product comprising a computer readable medium having computer readable code stored thereon, which, when executed by a processor, causes the processor to:
compute a time synchronization parameter as a function of time references generated at originating endpoints of a near-end signal and a far-end signal and at an entity where time synchronization is to be determined;
compute a set of time difference parameters between a near-end packet of a near-end signal and each far-end packet in a buffer having stored therein consecutively arranged packets of a far-end signal as a function of the time synchronization parameter;
compute indices of packets in the buffer corresponding to a preset delay range as a function of the time synchronization parameter; and
report at least one index to a module making use of the preset delay range.

48. A method for aligning signals in a packet-based network based on source and local timestamps comprising:
determining a relative delay between signals based on source and local timestamps of the signals; and
reporting the relative delay to a module making use of the relative delay.

49. An apparatus for aligning signals in a packet-based network based on source and local timestamps comprising:
a relative delay computation unit to compute a relative delay between signals based on source and local timestamps of the signals; and
a reporting module to report the relative delay to a module making use of the relative delay.
